(19) United States
(12) Patent Application Publication
(10) Pub. No.: US 2016/0071638 A1
(43) Pub. Date: Mar. 10, 2016

(54) SUPERCONDUCTING MAGNET DEVICE INCLUDING A CRYOGENIC COOLING BATH AND COOLING PIPES

(71) Applicant: Siemens Aktiengesellschaft, Muenchen (DE)

(72) Inventor: Neil Charles Tigwell, Witney (GB)

(73) Assignee: SIEMENS AG, Muenchen (DE)

(21) Appl. No.: 14/848,536

(22) Filed: Sep. 9, 2015

(30) Foreign Application Priority Data
Sep. 9, 2014 (GB) 1415880.2

(51) Int. Cl. H01F 6/04; F17C 3/08

(52) U.S. Cl. CPC H01F 6/04; F17C 3/085

(57) ABSTRACT

In a method for cooling a superconducting magnet device suitable for magnetic resonance imaging, and a cooling system, a small quantity of cryogen is used by cooling the magnet coils of the magnet device by a cooling pipe assembly, the cooling pipe assembly having one or more cooling pipes through which a cryogen flows. The one or more cooling pipes are in close thermal contact with the magnet coils. Liquid cryogen is filled into a cryogen vessel to provide a cryogenic temperature for at least parts of the magnet device for superconducting operation. The magnet coils are cooled during energizing of the magnet device by this cooling pipe assembly.

### BACKGROUND OF THE INVENTION

1. Field of the Invention

The present invention concerns a method for cooling a superconducting magnet device suitable for magnetic resonance imaging. Furthermore, the present invention concerns a cooling system for a superconducting magnet device suitable for magnetic resonance imaging.

2. Description of the Prior Art

Superconducting magnet devices are used for medical diagnosis, for example in magnetic resonance imaging (MRI) systems. A requirement of an MRI magnet is that it produces a stable, homogeneous, magnetic field. In order to achieve the required stability, it is common to use a superconducting magnet device which operates at very low temperature. The temperature is typically maintained by cooling the superconductor by means of a low temperature cryogenic fluid, also known as a cryogen, such as liquid helium.

The superconducting magnet device typically comprises a set of superconductor coils for producing a magnetic field, the coils being immersed in a cryogenic fluid to keep the coils at a superconducting temperature, the superconductor coils and the cryogen being contained within a cryogen vessel. For this purpose, the vessel contains a large amount of helium in order to provide a helium bath for large parts of the magnet coils. In other arrangements, the superconducting magnet is configured as minimum helium magnet, which preferably does not require cooling in a helium bath. Instead the magnet is cooled using much smaller quantities of cryogen.

Superconducting magnets are susceptible to quench events, in which, for a number of reasons, part of the superconducting magnet ceases to be superconducting. The resulting resistance in part of the magnet causes heat due to the current flowing through it. This rapidly causes further parts of the superconducting magnet to cease superconducting. The result is that all of the energy which was stored in the magnetic field of the magnet is suddenly released as heat. In a superconducting magnet cooled by a liquid cryogen, this typically results in rapid boil-off of a large volume of the cryogen, with gaseous and liquid cryogen being expelled from the cryostat at high speed.

During the process of supplying electrical current to the coils of the superconducting magnet (“ramping”) there is a potential risk of quenching events, in particular if a minimum helium magnet is employed. In case of minimum helium magnets it has been suggested to use displacers in the cryogen vessel to provide a greater wetted area for a given volume of helium.

For all types of magnets it is desirable to be able to transport the magnet device to the operational site in a dry, possible warm state, e.g. by sea shipment. However, once arrived at site it is necessary to cool the magnet down again. Typically, for this purpose, the vessel is filled in a first step with nitrogen. After a sufficiently low temperature has been reached, the nitrogen is blown out in a second step and the vessel is filled with liquid helium to provide cryogenic temperatures to the magnet coils in a third step. After the required temperature for ramping the magnet has been reached, all cooling is stopped, allowing the magnet to depressurise prior to ramping.

### SUMMARY OF THE INVENTION

As helium becomes more expensive and less readily available, it is desirable to reduce the amount of helium needed to cool down the superconducting magnet device after shipment and to operate a superconducting magnet device. It is therefore an object of the present invention to provide a simple technique for cooling a superconducting magnet device using a comparatively small quantity of cryogen.

This object is achieved according to the invention by a method for cooling a superconducting magnet device suitable for magnetic resonance imaging, that includes the steps of cooling down the magnet coils of the magnet device with a cooling pipe assembly, the cooling pipe assembly having one or more cooling pipes through which a cryogen flows, these one or more cooling pipes being in close thermal contact with the magnet coils, filling a liquid cryogen into a cryogen vessel to create a cryogenic temperature in at least parts of the magnet device for superconducting operation, and cooling the magnet coils during energizing of the magnet device by the cooling pipe assembly.

The object of the present invention is also achieved by a cooling system for a superconducting magnet device suitable for magnetic resonance imaging, having a cryogen vessel to contain a liquid cryogen reservoir to create a cryogenic temperature in at least parts of the magnet device for superconducting operation, and a cooling pipe assembly, the cooling pipe assembly having one or more cooling pipes that are in close thermal contact with the magnet coils of the magnet device, the cooling pipe assembly being designed to contain a cryogen to cool the magnet coils of the magnet device and to cool the magnet coils during energizing of the magnet device.

A basis of the invention is to provide a second cooling arrangement, that is operable completely independent of the liquid cryogen reservoir contained within the cryogen vessel. This second cooling arrangement in form of a cooling pipe assembly being in close thermal contact with the magnet device, and can be used to cool the magnet device after shipment of the magnet device in a dry cryogen vessel. More importantly, the second cooling arrangement can be used during ramping to cool the magnet in a cryogen filled vessel.

These and other aspects of the invention will be further elaborated on the basis of the following embodiments.

The cooling pipe assembly can be operated either using a cooling machine, such as a mechanically operated cooling machine, or using a supply vessel, for example a Dewar vessel. Despite that a cryogen vessel is typically of low pressure construction, with the present invention a high pressure mechanical cooling system can be used for cooling the magnet device, since the cooling pipes are preferably made in a way to withstand high pressure. Preferably, relatively narrow bore metal pipes are employed, which can stand very high pressures with no problems.

It is of further advantage that the cooling pipe assembly can be operated using a gaseous cryogen or a liquid cryogen, as required for an ideal cooling functionality. Furthermore, the mode of operation and the cooling medium can be changed without difficulty during a cooling process. For example, a high pressure cooler may be employed for cooling down the magnet by the cooling pipe assembly, thereby using nitrogen gas.

Subsequently, a Dewar vessel may be employed for further cooling down the magnet by the cooling pipe assembly, thereby using liquid helium. After a sufficiently low temperature has been reached, the magnet is energized. At the same time, the cooling pipe assembly may be employed to cool the magnet to prevent a ramping quench event.

Advantageously, the cooling process by operation of the cooling pipe assembly is preferably not interrupted or stopped during the step of filling cryogen into the cryogen vessel. It is of particular advantage, that the ramping process can take place immediately following the filling step. At this particular time, all relevant structural parts of the system are at their coldest, which eliminates any risk of cryogen boil-off Furthermore, there is no need to stop the cooling process, e.g. in order to depressurize the magnet prior to ramping. Because cooling by means of the cooling pipe assembly can be carried out during the complete ramping cycle, any heat generated by the magnet is extracted. The risk of quenching is thereby considerably reduced.

The present invention is particularly useful for minimum helium magnets, since the cooling effect of a minimum cryogen reservoir is increased by operation of the cooling pipe assembly, which provides a direct cooling to parts of the magnet device to which they are in close thermal contact.

In prior art magnet systems, cooling of the current lead, in particular cooling of the positive electrical connector, is often problematic. By means of the invention, a very efficient cooling of a current lead can be achieved in a simple manner by using a part of the cooling pipe assembly itself as current lead to supply electrical current to the magnet. Therefore, no additional electrical connections, e.g. conductors leading through the access neck, have to be provided, which would result in additional heat load to the magnet. The circulating cryogen will maintain the current lead at low temperature without any effect on magnet pressure or thermal environment, as it is the case in prior art.

As the cooling pipe assembly is housed within the cryogen vessel, it does not need to be perfectly leak tight, which allows a simple, low cost construction. With the present invention a simple technique is provided for cooling a superconducting magnet device using a comparatively small quantity of cryogen.

### BRIEF DESCRIPTION OF THE DRAWINGS

FIG. 1 schematically illustrates a cryostat.

FIG. 2 shows a detail of the electrical connection to the magnet device.

### DESCRIPTION OF THE PREFERRED EMBODIMENTS

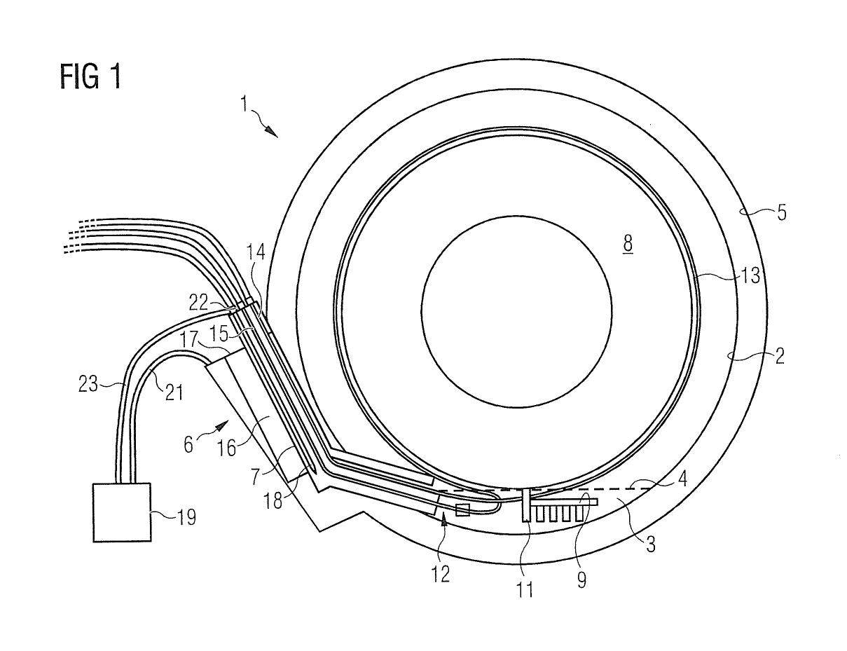

FIG. 1 shows a cryostat 1 such as may be employed for holding a magnet device for an MRI (magnetic resonance imaging) system. In the illustrated embodiment, a minimum helium magnet is employed, i.e. the magnet does not require cooling in a helium bath, instead parts of the magnet are cooled directly using small quantities of helium.

A cryogen vessel 2 holds a liquid cryogen 3, e. g. liquid helium. During operation, the helium reservoir is at a maximum cryogen level 4. The cryogen vessel 2 is contained in a vacuum jacket 5. 5 One or more heat shields (not shown) may be provided in the vacuum space between the cryogen vessel 2 and the vacuum jacket 5. A turret 6 with an access neck 7 is provided near the bottom of the cryostat 1, allowing access to the cryogen vessel 2 from the exterior. This is used to fill the cryogen vessel 2 and to provide access for connections to superconductive magnet coils 8 housed within the cryogen vessel 2. Besides the magnet coils 8, the magnet device has a termination board 9, with switches and other parts for operating the magnet. From the termination board 9 conductors (not shown) lead to the magnet coils 8.

Since a minimum helium magnet is used, the termination board 9 is immersed in the helium reservoir during operation of the magnet, thereby being cooled directly. For cooling the magnet coils 8 during operation a cold finger 11 is employed, which projects into the helium reservoir.

The cooling system of the magnet device has a cooling pipe assembly 12 with a cooling pipe 13 arranged within the cryogen vessel 2. The cooling pipe 13 is a relatively narrow bore pipe made of metal, preferably made of copper or stainless steel. The cooling pipe 13 is designed as a closed loop and comprises an inlet 14 and an outlet 15. The cooling pipe 13 forms a number of cooling loops (windings) around the magnet coils 8, thereby being in close thermal contact to the magnet coils 8 in a way that allows to withdraw sufficient heat from the magnet coils 8. Preferably, the cooling pipe 13 is at least partially in mechanical contact with the outer surface of the magnet coils 8.

In FIG. 1, for clarity, only a single winding is depicted. Typically, a large number of windings are provided. Generally, the cooling loops can be realized either as a continuous pipe arrangement or as a split pipe, e.g. with an optimized flow design.

The cooling system further has a high pressure mechanical cooling machine and a Dewar vessel (both not shown), each being connectable via the turret 6 to inlet 14 and outlet 15 of the cooling pipe 13. The connections can be achieved via detachable vacuum insulated tubes connecting at the thermal interface 16, which is arranged to intercept radiation and conduction heat loads to the cryogen vessel 2. In the illustrated embodiment inlet 14 and outlet 15 terminate at the turret outer jacket 17.

After transportation of such a cryostat 1 in a dry and warm state, a cooling process is started by connecting the high pressure cooler to bring the magnet temperature down to about 50 K. This pre-cooling procedure is continued using liquid helium from a Dewar vessel. Toward the end of the cooling process, the cryogen vessel 2 is filled from the Dewar vessel, e.g. be opening an additional valve (not shown), via a conventional siphon tube 18 which projects into the cryogen vessel 2, to provide cryogenic temperatures to at least parts of the magnet for superconducting operation. After a sufficiently low temperature for ramping the magnet has been reached, normally all cooling would be stopped allowing the magnet to depressurise prior to ramping. With the invention, however, the siphon feed can be shut off allowing the pressure in the magnet to reduce while maintaining the cooling of the magnet directly via the cooling pipe 13. During ramping the magnet coils 8 are further cooled by the cooling pipe 13, thereby avoiding the risk of a ramping quench.

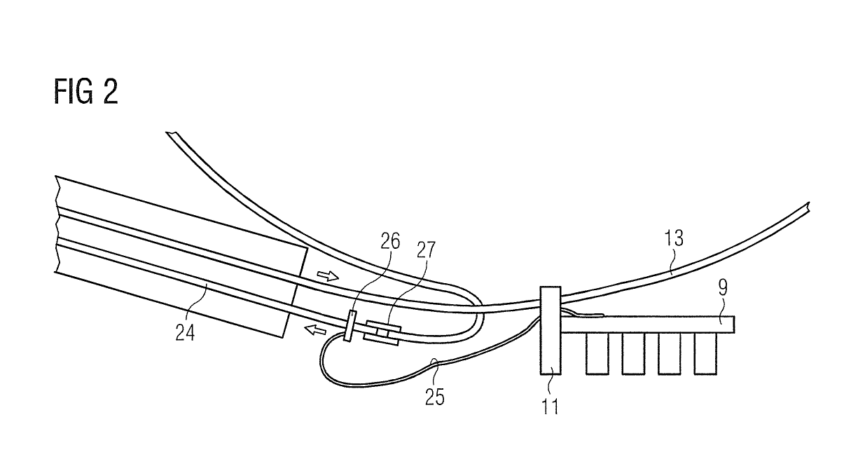

For providing electrical current to the magnet, a magnet power supply 19 is used. A negative electrical connection 21 is provided to the magnet through the body of the cryostat 1. Instead of providing a positive electrical connection by an additional conductor, the outlet 15 of the cooling pipe 13 itself is used as the positive current lead to supply electrical current to the termination board 9. For this purpose, the outlet terminal 22 is connected to the positive connection 23 of the power supply 19. As it is illustrated in FIG. 2, the current lead section 24 of the outlet 15 is connected to a cable 25 which establishes the electric connection between the outlet 15 and the termination board 9.

Following the connecting point 26 of the cable 25, towards the interior of the cryogen vessel 2, the current lead section 24 of the outlet 15 is electrically isolated by means of a suitable isolator 27, which for example is made from ceramic material. Additional pressure may be required at the Dewar vessel to overcome any boiling effect of helium in the current lead section 24. This would be helped by maintaining a very low pressure outlet for the exhausted helium gas. As the quantity of gas would be small it is possible to vent via a low pressure check valve direct to atmosphere.

It will be evident to those skilled in the art that the invention is not limited to the details of the foregoing illustrative embodiments, and that the present invention may be embodied in other specific forms without departing from the scope of the invention. For example, the cooling pipe assembly may be used for a conventional flooded magnet device, thereby allowing additional cooling as well. Instead of helium, other cryogens may be used, for example nitrogen, hydrogen or a combination thereof.

I claim as my invention:

1. A superconducting magnet device comprising:
magnet coils;
a cryogen vessel housing the magnet coils;
a cooling pipe assembly comprising at least one cooling pipe in thermal contact with the magnet coils; and
the cooling pipe assembly being arranged within the cryogen vessel and comprising an inlet pipe and an outlet pipe, said inlet pipe and outlet pipe terminating outside the cryogen vessel.

2. The superconducting magnet device as claimed in claim 1, wherein the at least one cooling pipe of the cooling pipe assembly forms multiple cooling loops.

3. The superconducting magnet device as claimed in claim 1, wherein the at least one cooling pipe of the cooling pipe assembly forms a closed loop.

4. The superconducting magnet device as claimed in claim 1, comprising a high pressure cooler and outside the cryogen vessel, connected to said cooling pipe assembly by said inlet pipe and outlet pipe.

5. The superconducting magnet device as claimed in claim 1, comprising a supply vessel and outside the cryogen vessel, connected to said cooling pipe assembly by said inlet pipe and outlet pipe.

6. The superconducting magnet device as claimed in claim 1, wherein at least one part of said cooling pipe assembly is connected as a current lead to supply electrical current to the magnet coils.

7. A method for cooling a superconducting magnet device comprising magnet coils in a cryogen vessel, said method comprising:
cooling the magnet coils before energizing the magnet coils with a cooling pipe assembly, by introduction of a cryogen into the cooling pipe assembly through an inlet pipe and out through an outlet pipe that both terminate outside of said cryogen vessel;
partially filling the cryogen vessel with a liquid cryogen to provide a cryogenic temperature to at least parts of said magnet coils for superconducting operation; and
cooling the magnet coils during energizing of the magnet coils by further introduction of a cryogen into said cooling pipe assembly through said inlet pipe (14) and out through said outlet pipe.

8. The method as claimed in claim 7, comprising cooling the magnet coils before said energizing thereof using a cooler to provide the cooling pipe assembly with the cryogen.

9. The method as claimed in claim 7, comprising cooling the magnet coils during said energizing thereof the magnet coils using a cooler to provide the cooling pipe assembly with the cryogen.

10. A method as claimed in claim 7, comprising cooling the magnet coils before said energizing thereof with cryogen provided to said cooling pipe assembly from a supply vessel.

11. A method as claimed in claim 7, comprising cooling the magnet coils during said energizing thereof with cryogen provided to said cooling pipe assembly from a supply vessel.

12. The method as claimed in claim 7, comprising cooling the magnet coils during energizing, using at least one part of the cooling pipe assembly as a current lead to supply electrical current to the magnet device.
